(19) United States
(12) Patent Application Publication
(10) Pub. No.: US 2010/0071838 A1
(43) Pub. Date: Mar. 25, 2010

(54) MANUFACTURING METHOD OF PNEUMATIC TIRE

(75) Inventor: Kazuma Nishitani, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/500,739

(22) Filed: Jul. 10, 2009

(30) Foreign Application Priority Data
Sep. 25, 2008 (JP) 2008-246297

(51) Int. Cl. B29D 30/16

(52) U.S. Cl. 156/116

(57) ABSTRACT

A double-layer rubber ribbon in which at least one surface of an outer surface is configured by a sheet-like thin rubber ribbon is formed by co-extruding a different color rubber ribbon having a second color different from a side rubber of a first color and the thin rubber ribbon. Further, the double-layer rubber ribbon is wound for one or more turns along a tire circumferential direction in such a manner that the thin rubber ribbon is positioned close to a carcass side. Thereafter, the wound double-layer rubber ribbon is covered by a cover rubber having the first color, and the different color rubber ribbon is exposed by scraping off a portion corresponding to a letter or a line of the cover rubber.

### BACKGROUND OF THE INVENTION

1. Field of the Invention

The present invention relates to a manufacturing method of a pneumatic tire in which a letter or a line having a color different from a side rubber is formed in a side wall portion.

2. Description of the Related Art

Conventionally, for a purpose of enhancing a fashion property or the like, there has been known a pneumatic tire in which a letter or a line having a color different from a side rubber is formed in a sidewall portion. In WO 04/037524 brochure and Japanese Unexamined Patent Publication No. 9-1694, there has been disclosed a tire in which a different color rubber (for example, a white rubber) having a color different from a side rubber is arranged in an outer side of a carcass of the side wall portion, the different color rubber is covered by a cover rubber having the same color as the side rubber, and the different color rubber is exposed by scraping off the cover rubber in a shape of the letter or the line.

In such a tire, if the different color rubber directly comes into contact with a ply material constructing the carcass, peeling tends to be generated based on deterioration of an adhesive property of the different color rubber, and there is a problem that durability is lowered. Further, there is a problem that a discoloring component such as an age register or the like is transferred from the ply material, whereby the different color rubber is stained. With regard to such problems of the durability and the stain resistance, conventionally, a cushion rubber with anti-staining property is additionally arranged in the carcass side of the different color rubber.

However, since the cushion rubber having anti-staining property is expensive, a material cost is increased. Further, since the cushion rubber is extruded in a single layer as a ribbon having a predetermined thickness, it is difficult to lower the cost by reducing the thickness, and the cushion rubber is constrained to be arranged in an independent step from the different color rubber, and is not preferable in view of productivity and the number of parts. Accordingly, there has been a strong demand for proposing a method which can improve the durability and the stain resistance without arranging the anti-staining property cushion rubber.

### SUMMARY OF THE INVENTION

The present invention is made in view of above-mentioned problems, and an object of the present invention is to provide a manufacturing method of a pneumatic tire which can achieve excellent durability and strain resistance while forming a letter or a line having a color different from a side rubber in a side wall portion.

The object can be achieved by the following present invention. That is, the present invention provides a manufacturing method of a pneumatic tire in which a letter or a line of a second color different from a side rubber of a first color is formed in a side wall portion in at least one side, the method comprising the steps of:

forming a double-layer rubber ribbon in which at least one surface of an outer surface is configured by a sheet-like thin rubber ribbon, by co-extruding a different color rubber ribbon having the second color and the thin rubber ribbon;

winding the double-layer rubber ribbon for one or more turns along a tire circumferential direction in such a manner that the thin rubber ribbon is positioned close to a carcass side; and

covering the wound double-layer rubber ribbon by a cover rubber having the first color, and exposing the different color rubber ribbon by scraping off a portion corresponding to the letter or the line of the cover rubber.

In the manufacturing method of the pneumatic tire according to the present invention, since the double-layer rubber ribbon formed by co-extruding the different color rubber ribbon and the thin rubber ribbon is wound such that the thin rubber ribbon is positioned close to the carcass side, it is possible to enhance the stain resistance and to secure the durability by avoiding the contact between the different color rubber and the ply material. According to the present invention, since the conventionally used cushion rubber can be excluded, it is possible to anticipate an improvement in productivity and a reduction in the number of parts, as well as an advantage in the cost.

In the present invention, it is preferable that the double-layer rubber ribbon is arranged in an overlapping manner in a tire width direction by being wound two or three turns along the tire circumferential direction. Accordingly, it is possible to secure uniformity of a tire and workability at the time of exposing the different color rubber ribbon. In other words, if the double-layer rubber ribbon is wound for one turn, there is a tendency that the uniformity of the tire is reduced because of an enlargement of a step of a joint portion. On the other hand, if the double-layer rubber ribbon is wound for four or more turns, a thickness of the different color rubber ribbon per one turn becomes small, and the different color rubber ribbon is also scraped at the time of scraping off the cover rubber, so that an inner thin rubber ribbon tends to be exposed.

In the present invention, it is preferable that a thickness of the thin rubber ribbon is between 0.2 and 0.5 mm. Accordingly, it is possible to well enhance the stain resistance by making a volume of the thin rubber ribbon small. In the present invention, since the different color rubber ribbon is co-extruded with the thin rubber ribbon, it is possible to highly reduce the thickness of the thin rubber ribbon compared to the extrusion of the single layer, and it is possible to form in the thickness range as mentioned above.

In the present invention, it is preferable a cross section of the double-layer rubber ribbon is comparted in such a manner that the thin rubber ribbon is arranged in an inner side in a tire diametrical direction of the different color rubber ribbon on winding the double-layer rubber ribbon. Accordingly, since the thin rubber ribbon is interposed between the different color rubber ribbon, and the side rubber arranged in a bead portion side or a rim strip rubber arranged in the bead portion, a further improving effect can be obtained in durability and stain resistance.

### BRIEF DESCRIPTION OF THE DRAWINGS

FIG. 1 is a half cross sectional view of a tire meridian schematically showing an example of a pneumatic tire;

FIG. 2 is a cross sectional view schematically showing an example of a procedure forming a side rubber;

FIG. 3 is a cross sectional view of a double-layer rubber ribbon;

FIG. 4 is a schematic configuration view showing manufacturing equipment for winding the double-layer rubber ribbon;

FIG. 5 is a cross sectional view schematically showing an example of a procedure of forming a side rubber; and

FIG. 6 is a cross sectional view of a double-layer rubber ribbon in another embodiment.

### DETAILED DESCRIPTION OF THE PREFERRED EMBODIMENTS

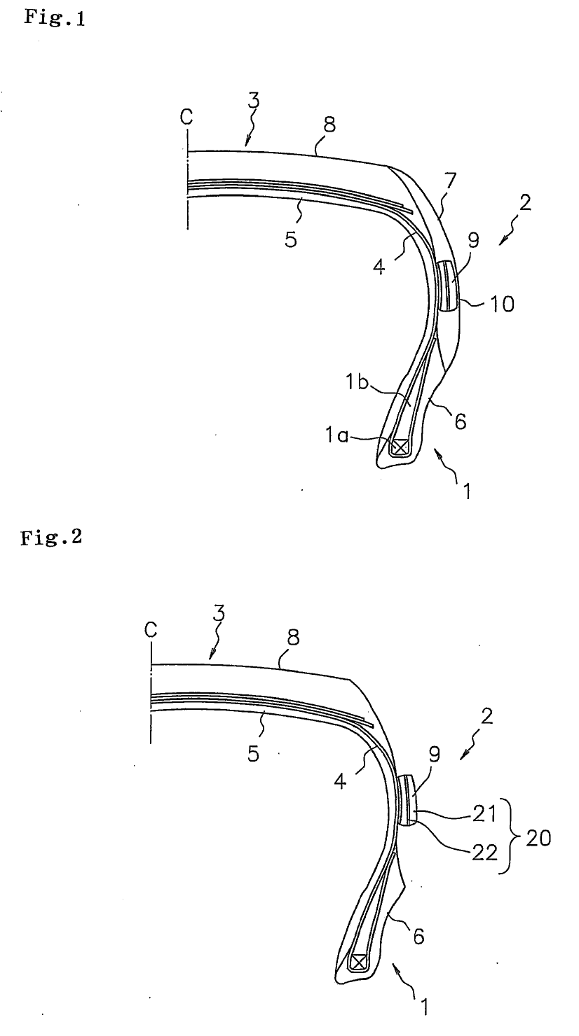

An embodiment of the present invention will be explained with reference to the drawings. FIG. 1 is a half cross sectional view of a tire meridian schematically showing an example of a pneumatic tire. The pneumatic tire comprises a pair of bead portions 1 in which a bead 1a and a bead filler 1b, sidewall portions 2 extending from respective bead portions 1 radially outward of the tire, and a tread portion 3 connected to the respective sidewall portions 2 radially outward of the tire.

A carcass 4 constructed by at least one ply material is arranged between a pair of bead portions 1. The ply material covers by rubber a cord arranged at approximately 90 degrees with respect to a tire equator line C, and the cord can employ steel, or an organic fiber such as polyester, rayon, nylon, aramid and the like. The carcass 4 is arranged so as to be bridged between the pair of bead portions 1, and an end portion thereof is wound up to an outer side by the bead core 1a so as to be locked.

An inner liner rubber 5 is arranged in an inner peripheral side of the carcass 4 for holding an air pressure. Further, a rim strip rubber 6 coming into contact with a rim flange is arranged in the bead portion 1, a side rubber 7 is arranged in a carcass outer periphery of the side wall portion 2, and a tread rubber 8 is arranged in an outer periphery of the tread portion 3, respectively. Each of these rubbers has a black color, and the black color corresponds to the first color.

A different color rubber 9 having a color different from the side rubber 7 is arranged in at least one side of the side wall portion 2. The different color rubber 9 of the present embodiment has a white color, and the white color corresponds to the second color. The different color rubber 9 is covered by a thin cover rubber 10 having a black color, and a white letter or line is formed by scraping off the cover rubber 10 in a shape of the letter or the line so as to partly expose the different color rubber 9.

A manufacturing method of the pneumatic tire according to the present invention can employ a conventionally known method except a step relating to the sidewall portion 2, and the pneumatic tire mentioned above can be manufactured, for example, by the following procedure. In other words, an uncured tire as shown in FIG. 1 is formed by attaching a ply material constructing the carcass 4 to an outer periphery of the inner liner rubber 5 formed in a cylindrical shape, externally inserting the bead core 1a and the bead filler 1b, winding up an end portion of the carcass 4 as well as inflating a center portion, attaching the belt and the tread rubber 8 to a tread portion, and thereafter forming the side rubber 7.

A description will be given in detail below of forming of the side rubber 7 in the above procedure. First of all, as shown in FIG. 2, the different color rubber 9 is arranged in a region forming a letter or a line, with respect to the side wall portion 2 of a half-finished tire formed in a toroidal shape. The different color rubber 9 is arranged by winding an uncured different color rubber ribbon 21 formed in a band shape along a tire circumferential direction for one turn or more.

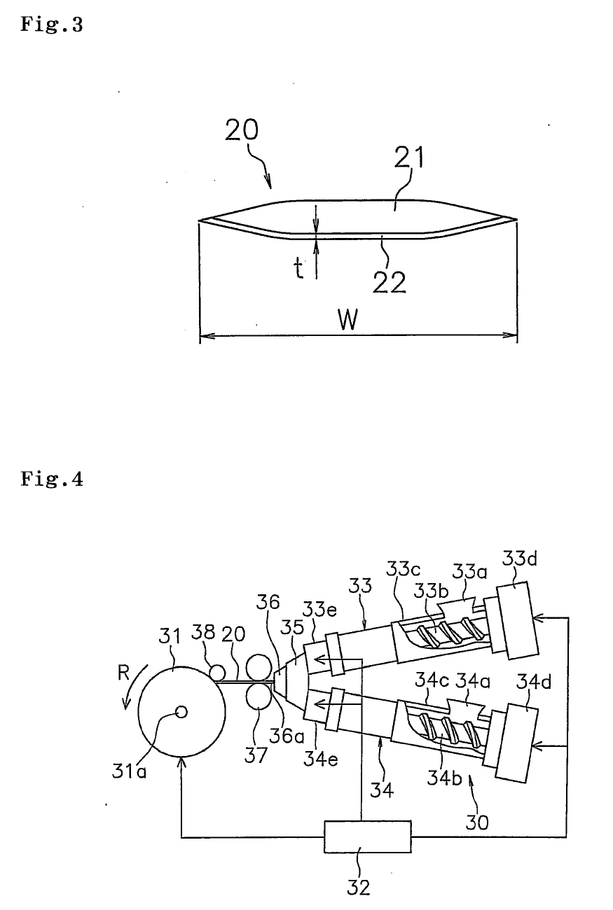

In the present embodiment, a double-layer rubber ribbon 20 as shown in FIG. 3 is used, and the different color rubber ribbon 21 is provided in such a mode that it is co-extruded with a sheet-like thin rubber ribbon 22. The double-layer rubber ribbon 20 is formed by co-extruding the different color rubber ribbon 21 and the thin rubber ribbon 22, and at least one surface (a bottom surface in FIG. 3) of an outer surface is constructed by the thin rubber ribbon 22. The thin rubber ribbon 22 may be formed by a black colored rubber, or may be formed by reducing the thickness of the side rubber 7.

The arrangement of the different color rubber 9 can be carried out by using manufacturing equipment as shown in FIG. 4. The manufacturing equipment is provided with a rubber ribbon forming apparatus 30 which can form the double-layer rubber ribbon 20 by co-extruding the different color rubber ribbon 21 and the thin rubber ribbon 22, a rotation support body 31 around which the double-layer rubber ribbon 20 supplied from the rubber ribbon forming apparatus 30 is wound, and a control apparatus 32 controlling operations of the rubber ribbon forming apparatus 30 and the rotation support body 31.

The rubber ribbon forming apparatus 30 is provided with a pair of extruding machines 33 and 34, a rubber combined portion 35 provided in common in leading ends of the extruding machines 33 and 34, and a mouth piece 36 additionally provided in a leading end of the rubber combined portion 35, and a discharge port 36a of the mouth piece 36 is open in a shape corresponding to a cross sectional shape of the double-layer rubber ribbon 20. The rotation support body 31 is structured so as to be rotatable in a direction R around a shaft 31a, and is structured so as to be movable in an axial direction.

The extruding machine 33 is provided with a hopper 33a into which a rubber material is put, a screw 33b discharging the rubber material forward, a barrel 33c having the screw 33b built therein, a drive apparatus 33d driving the screw 33b, and a head portion 33e having a gear pump built therein. The extruding machine 34 is structured in the same manner as the extruding machine 33, and is provided with a hopper 34a, a screw 34b, a barrel 34c, a drive apparatus 35d, and a head portion 35e. The control apparatus 32 controls driving and braking of the screws 33b and 34b and the gear pump, and a rotation and a movement in an axial direction of the rotation support body 31.

If the rubber material of the different color rubber ribbon 21 is put into the hopper 33a, and the rubber material of the thin rubber ribbon 22 is put into the hopper 34a, each of the rubber materials is discharged forward while being mixed by the screws 33b and 34b, and is supplied to the rubber combined portion 35 via the head portions 33e and 34e. At this time, each of the rubber materials is supplied at a fixed amount to the rubber combined portion 35 by the gear pumps built into the head portions 33e and 34e.

The respective rubber materials are combined in the rubber combined portion 35, and the double-layer rubber ribbon 20 as shown in FIG. 3 is extruded from the discharge port 36a. The extruded double-layer rubber ribbon 20 is discharged forward while adjusting its cross sectional shape by a roll 37, and is wound around a half-finished tire (refer to FIG. 2) supported onto the rotation support body 31 along the tire circumferential direction. A roller 38 is provided for holding down the double-layer rubber ribbon 20.

As shown in FIG. 2, the double-layer rubber ribbon 20 is wound so that the thin rubber ribbon 22 is positioned close to the carcass 4 side. Accordingly, a contact between the different color rubber 9 and the ply material is avoided, and a stain resistance is enhanced. The thickness of the thin rubber ribbon 22 can be highly reduced by co-extrusion, and the stain resistance is preferably secured even if the thin rubber ribbon 22 is formed by the same kind of rubber as the side rubber 7 or the like. Further, since the different color rubber ribbon 21 and the thin rubber ribbon 22 are firmly bonded by the co-extrusion, and the different color rubber ribbon 21 does not come into contact with the ply material, it is possible to secure durability by suppressing peeling of the different color rubber 9.

The double-layer rubber ribbon 20 is wound for one or more turns, however, in view of securing workability at the time of exposing the different color rubber ribbon 21, it is preferable to wind within three turns. If it is wound for four or more turns, a thickness of the different color rubber ribbon 21 per one turn becomes small. Then, if the different color rubber ribbon 21 is also scraped at the time of scraping off the cover rubber 10, the inner thin rubber ribbon 22 is exposed and there tends to be an obstacle in forming the letter or the line. Further, it is preferable to wind for two or more turns in view of securing uniformity of the tire. Taking the above into account, it is preferable to wind the double-layer rubber ribbon 20 for two or three turns so as to arrange in an overlapping manner in a tire width direction.

A width W of the double-layer rubber ribbon 20 is not particularly limited, however, a width between 35 and 75 mm is exemplified. Further, the thickness of the different color rubber ribbon 21 is not particularly limited, however, the thickness between 2 and 4 mm to the maximum is preferable. If the thickness of the different color rubber ribbon 21 is not less than 2 mm, the exposure of the inner thin rubber ribbon 22 is suppressed even if the different color rubber ribbon 21 is scraped at the time of scraping off the cover rubber 10, so that it is possible to prevent an obstacle in forming the letter or the line.

The thin rubber ribbon 22 is formed thinner than the different color rubber ribbon 21, a thickness t thereof preferably satisfies a condition 0.2≦t≦0.5 mm, and more preferably satisfies a condition 0.2<t<0.5 mm. In view of enhancing the stain resistance, it is preferred that the thin rubber ribbon 22 is as thin as possible. In the present invention, the thickness of the thin rubber ribbon 22 can be highly reduced by the co-extrusion with the different color rubber ribbon 21, compared to the extruding of a single layer.

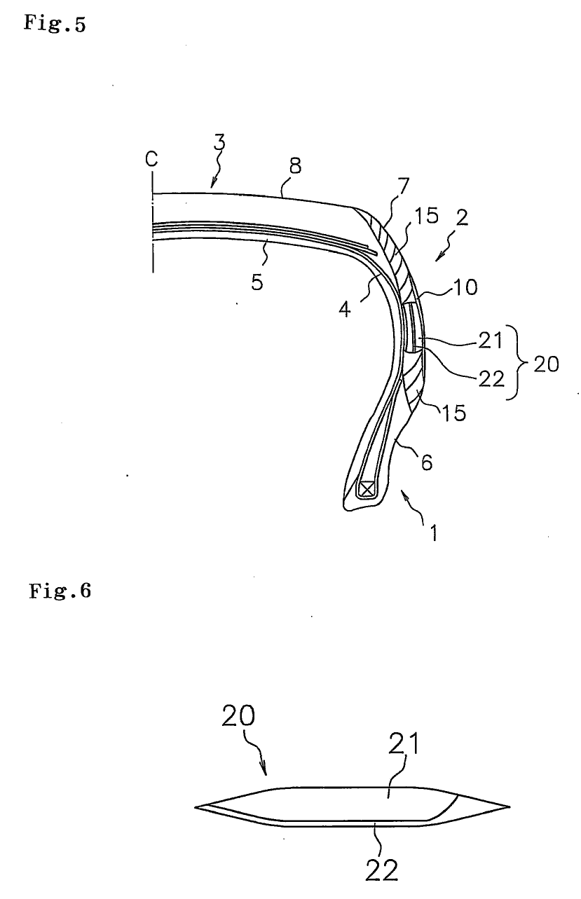

After arranging the different color rubber 9, the side rubber 7 is formed by filling the rubber in an outer side and an inner side in a tire diametrical direction, as shown in FIG. 5, and subsequently, the wound double-layer rubber ribbon 20 is covered by the sheet-like cover rubber 10. Accordingly, the uncured tire as shown in FIG. 1 can be obtained. The side rubber 7 can be precisely formed by winding the rubber ribbon 15 along the tire circumferential direction. The different color rubber 9 may be arranged after forming the side rubber 7.

A white letter or line is formed in the side wall portion 2, by scraping off a portion corresponding to the letter or the line of the cover rubber 10 by buffing or the like, and partly exposing the different color rubber ribbon 21 (the different color rubber 9), after curing the formed tire.

### Other Embodiment

(1) The cross sectional shape of the double-layer rubber ribbon 20 is not limited to the shape shown in the embodiment mentioned above, but can employ other shapes such as a triangular shape, a rectangular shape, an oval shape, a trapezoidal shape, and the like. Further, in a case that the cross section of the double-layer rubber ribbon 20 is comparted as shown in FIG. 6, the thin rubber ribbon 22 is also arranged in the inner side in the tire diametrical direction of the different color rubber ribbon 21 at the time of winding the double-layer rubber ribbon 20. In this case, since the thin rubber ribbon 22 can be interposed between the different color rubber ribbon 21, and the side rubber 7 arranged in the bead portion side or the rim strip rubber 6 arranged in the bead portion 1, it is possible to obtain a further improved effect in the durability and the stain resistance.

(2) In the present invention, the different color rubber 9 can be arranged in both sides of the side wall portion 2. In this case, a rubber hardness of the thin rubber ribbon 22 positioned in the outer side of the vehicle is preferably made higher than a rubber hardness of the thin rubber ribbon 22 positioned in the inner side of the vehicle, whereby it is possible to enhance the rigidity in the outer side of the vehicle in the tire so as to improve a steering stability.

(3) In the above-mentioned embodiment, there is shown the example in which the double-layer rubber ribbon 20 formed by laminating the different color rubber ribbon 21 and the thin rubber ribbon 22 is wound for two turns so as to be arranged overlapping in the tire width direction, however, in the present invention, the extrusion of the thin rubber ribbon 22 may be stopped at the time of winding the double-layer rubber ribbon on and after the second turn, and the outer peripheral side may be formed in a single layer of the different color rubber ribbon 21. Accordingly, it is possible to effectively enhance the stain resistance of the different color rubber 9.

Such an operation can be simply carried out by using the above-mentioned manufacturing equipment. In other words, the extrusion of the thin rubber ribbon 22 may be stopped by restraining the rotation of the gear pump within the head portion 34e at the time of winding the double-layer rubber ribbon 20 for one turn, and restraining the rotation of the screw 34b if necessary. At this time, it is possible to increase an extruding amount of the different color rubber ribbon 21 so as to maintain the cross sectional shape of the double-layer rubber ribbon 20, by increasing a rotating speed of the gear pump within the head portion 33e, and increasing a rotating speed of the screw 33b if necessary. Such operation control of the gear pump and the screw can be carried out by the control apparatus 32.

(4) In the above-mentioned embodiment, there is shown the example in which the different color rubber 9 is arranged by winding the double-layer rubber ribbon 20 around the side wall portion 2 of the half-finished tire in which the center portion of the carcass 4 is expanded and deformed, however, the present invention may be structured such that the different color rubber 9 is arranged by winding the double-layer rubber ribbon 20 around the outer periphery of the carcass 4 before expanding and deforming the center portion.

### EXAMPLE

An example tire which concretely shows the structure and effect of the present invention will be explained. An evaluation of each of performances is executed as follows.

(1) Durability

A durability test is carried out based on new United States Tire Testing Standards (FMVSS139). An evaluation is carried out by an index number by setting a result of a comparative example 1 to 100, and the greater numerical value indicates a more excellent durability.

(2) Stain Resistance

After an accelerated deterioration test within a gear oven at 70° C., a degree of discoloration is checked by a visual observation, and an evaluation is carried out based on three stages including ◯: as good as new, Δ: slightly discolored, ×: apparently discolored.

(3) Material Cost

A material cost is calculated based on a used amount of each of the different color rubber, the side rubber and the anti-staining cushion rubber required for manufacturing the tire, and a cost and a compounding amount of a compounding agent used in each of the members. An evaluation is carried out by an index number by setting a result of the comparative example 1 to 100, and the greater numerical value indicates a smaller material cost.

(4) Productivity

Productivity is evaluated by measuring a time required for the tire forming including a stage change based on a tire size. An evaluation is carried out by an index number by setting a result of the comparative example 1 to 100, and the greater numerical value indicates a shorter forming time, that is, a more excellent productivity.

(5) Uniformity

A uniformity of the tire is evaluated by measuring a radial force variation (RFV) based on a testing method defined in JISD4233. Specifically, the method measures a deforming amount of a reaction force in a radial direction generated at the time of pressing the tire to the rotating drum so that a predetermined load is applied, and rotating the tire while keeping an interval between both shafts constant. An evaluation is carried out by an index number by setting a result of the comparative example 1 to 100, and the greater numerical value indicates a smaller the deforming amount, that is, a more excellent uniformity.

### COMPARATIVE EXAMPLES 1 to 4

Comparative examples 1 to 4 are set to a tire in which an anti-staining cushion rubber is additionally arranged in a carcass side of a different color rubber, at the time of manufacturing a pneumatic tire having a size LT265/75R16 123Q 10PR. The different color rubber is arranged by winding a different color rubber ribbon having a single layer, and a ribbon thickness and a winding number thereof are as shown in Table 1. A cushion rubber is arranged by winding a rubber ribbon having a thickness of 0.6 mm for one turn. Further, a comparative example 5 is set to a tire which is structured in the same manner as the comparative example 2 except that the anti-staining cushion rubber is not arranged.

### EXAPLES 1 to 5

Examples 1 to 5 are set to a tire in which a different color rubber is arranged by winding a double-layer rubber ribbon in the same manner as the above-mentioned embodiment, at the time of manufacturing a pneumatic tire having a size LT265/75R16 123Q 10PR. A thickness and a winding number of each of the ribbons in the double-layer rubber ribbon are as shown in Table 1. A thin rubber ribbon is formed by the same rubber as the side rubber. Results of the evaluation are shown in Table 1.

TABLE 1

| | | Ribbon | | | | | | | |
|---|---|---|---|---|---|---|---|---|---|
| | | thickness | | | | | | | |
| | | of | Ribbon | | | | | | |
| | Thickness | different | thickness | Winding | | | | | |
| | of cushion | color | of thin | number | | Stain | Material | | |
| | rubber (mm) | rubber (mm) | rubber (mm) | (turn) | Durability | resistance | cost | Productivity | Uniformity |
| Comparative | 0.6 | 6 | — | 1 | 100 | ◯ | 100 | 100 | 100 |
| example 1 | | | | | | | | | |
| Comparative | 0.6 | 3 | — | 2 | 100 | ◯ | 100 | 98 | 102 |
| example 2 | | | | | | | | | |
| Comparative | 0.6 | 2 | — | 3 | 100 | ◯ | 100 | 96 | 104 |
| example 3 | | | | | | | | | |
| Comparative | 0.6 | 1 | — | 6 | 100 | ◯ | 100 | 94 | 106 |
| example 4 | | | | | | | | | |
| Comparative | — | 3 | — | 2 | 70 | Δ | 100 | 115 | 102 |
| example 5 | | | | | | | | | |
| Example 1 | — | 6 | 0.5 | 1 | 100 | ◯ | 105 | 110 | 100 |
| Example 2 | — | 3 | 0.5 | 2 | 100 | ◯ | 105 | 108 | 102 |
| Example 3 | — | 2 | 0.5 | 3 | 100 | ◯ | 105 | 106 | 104 |
| Example 4 | — | 1 | 0.5 | 6 | 100 | ◯ | 105 | 104 | 106 |
| Example 5 | — | 3 | 0.8 | 2 | 100 | X | 105 | 108 | 102 |

As shown in Table 1, in the comparative examples 1 to 4 using the anti-staining cushion rubber, the material cost is comparatively high and the productivity is comparatively low. Further, in the comparative example 5, since the different color rubber is structured such as to come into contact with the ply material constructing the carcass, the durability is deteriorated. On the contrary, in the examples 1 to 5, the excellent durability and stain resistance can be achieved while well securing the material cost and the productivity.

In the examples 1 to 5, the examples 2 to 5 are comparatively good in uniformity, and it can be known that the double-layer rubber ribbon is preferably wound for two or more turns. In this case, in the example 4, since the inner thin rubber ribbon tends to be exposed at the time of buffing the cover rubber, the double-layer rubber ribbon is preferably wound for two or three turns. In the example 5, since the thickness of the thin rubber ribbon is comparatively large, the stain resistance is somewhat inferior, so that the thickness of the thin rubber ribbon is preferably not more than 0.5 mm.

What is claimed is:

1. A manufacturing method of a pneumatic tire in which a letter or a line of a second color different from a side rubber of a first color is formed in a side wall portion in at least one side, the method comprising the steps of:
forming a double-layer rubber ribbon in which at least one surface of an outer surface is configured by a sheet-like thin rubber ribbon, by co-extruding a different color rubber ribbon having the second color and the thin rubber ribbon;
winding the double-layer rubber ribbon for one or more turns along a tire circumferential direction in such a manner that the thin rubber ribbon is positioned close to a carcass side; and
covering the wound double-layer rubber ribbon by a cover rubber having the first color, and exposing the different color rubber ribbon by scraping off a portion corresponding to the letter or the line of the cover rubber.

2. The manufacturing method of a pneumatic tire according to claim 1, wherein the double-layer rubber ribbon is arranged in an overlapping manner in a tire width direction by being wound two or three turns along the tire circumferential direction.

3. The manufacturing method of a pneumatic tire according to claim 1, wherein a thickness of the thin rubber ribbon is between 0.2 and 0.5 mm.

4. The manufacturing method of a pneumatic tire according to claim 1, wherein a cross section of the double-layer rubber ribbon is comparted in such a manner that the thin rubber ribbon is arranged in an inner side in a tire diametrical direction of the different color rubber ribbon on winding the double-layer rubber ribbon.
